(19) United States
(12) Patent Application Publication
(10) Pub. No.: US 2006/0116276 A1
(43) Pub. Date: Jun. 1, 2006

(54) Method for processing catalysts for color number hydrogenation of polytetrahydrofuran and/or the esters thereof

(76) Inventors: Volkmar Menger, Neustadt (DE); Michael Schwarztrauber, Neustadt (DE)

Correspondence Address: CONNOLLY BOVE LODGE & HUTZ, LLP, P O BOX 2207, WILMINGTON, DE, 19899, US

(21) Appl. No.: 10/542,574

(22) PCT Filed: Jan. 10, 2004
(86) PCT No.: PCT/EP04/00120

§ 371 Date: Jul. 19, 2005

(30) Foreign Application Priority Data
Jan. 20, 2003 (DE) 103-01-833.6

(51) Int. Cl. B01J 38/06

(52) U.S. Cl. 502/55

(57) ABSTRACT

Process for working up an at least partially deactivated hydrogenation catalyst for the color number hydrogenation of PTHF and/or PTHF esters, in which the hydrogenation catalyst is purified by treatment with steam at from 100 to 250° C. and a gauge pressure of from 0 to 40 bar.

The invention relates to a process for working up at least partially deactivated catalysts which have been used for the preparation of polytetrahydrofuran, polytetrahydrofuran monoesters and diesters having a low color number by treatment with hydrogen, referred to as color number hydrogenation.

It is known from DE-A 31 12 065 that the treatment of polytetrahydrofuran (hereinafter referred to as “PTHF”) or polytetrahydrofuran monoesters and/or diesters (hereinafter referred to as “PTHF esters”) with hydrogen in the presence of hydrogenation catalysts leads to corresponding polymers having a low color number. Possible PTHF esters are, in particular, PTHF monoacetates, PTHF diacetates or mixtures thereof which are obtainable by polymerization of tetrahydrofuran (hereinafter referred to as “THF”) in a manner known per se, preferably in the presence of acetic anhydride over various hydrogenation catalysts.

In general, hydrogenation catalysts tend to lose activity and selectivity as the number of hours of operation increases. After reaching a limiter value which is no longer acceptable, the hydrogenation catalyst of an industrially operated color number hydrogenation process has to be replaced by a fresh hydrogenation catalyst having a high activity and selectivity.

The replacement of the exhausted, deactivated catalyst is generally associated with a purification procedure by means of which the exhausted catalyst is freed of adhering product, in particular PTHF and PTHF esters.

The usual procedure for the hydrogenation catalysts used for the color number hydrogenation is to empty the PTHF or PTHF ester from the reactor and then rinse the still product-containing catalyst in the reactor with hot water having a temperature of about 60-90° C., either discontinuously a number of times or continuously. This results in large quantities of rinsing water. The rinsing water obtained has to be worked up. Moreover, the removal of adhering impurities from the catalyst is incomplete since, for example, PTHF diacetates are insoluble in water.

As a result of the incomplete cleaning of the hydrogenation catalyst by the rinsing with hot water, conglutination of the catalyst particles to form larger units such as granules or lumps occurs when the catalyst is removed from the reactor by means of suction, which is usually associated with cooling. The removal of the catalyst from the reactor by means of suction which is required in the industrial processes is made difficult or impossible. The hydrogenation catalyst removed from the reactor is also still highly contaminated after the purification procedure.

As an alternative, the catalyst can be washed with solvents such as methanol. Although this gives a free-flowing catalyst which can readily be removed by means of suction, disadvantages are the long time of a number of days required for this procedure and the costly work-up necessary for the methanol used for washing.

It is an object of the present invention to provide a process for working up exhausted catalysts which have been used for the preparation of PTHF, PTHF monoesters and/or PTHF diesters having a low color number by treatment with hydrogen, which allows a quick and inexpensive change of catalyst and which gives a worked-up catalyst which is largely free of product residues and can readily be handled in subsequent disposal.

We have found that this object is achieved by a process for working up an at least partially deactivated hydrogenation catalyst for the color number hydrogenation of PTHF and/or PTHF diesters, in which the hydrogenation catalyst is purified by treatment with steam at a temperature of generally from 100 to 250° C., preferably from 100 to 200° C., particularly preferably from 100 to 150° C., and a gauge pressure of generally from 0 to 40 bar, preferably from 1 to 16 bar, particularly preferably from 2 to 4 bar. The purified hydrogenation catalyst for the color number hydrogenation of PTHF and/or PTHF esters can be passed to disposal in a second step. It is preferably passed to metal recovery, but it is also possible to deposit the purified hydrogenation catalyst in a landfill, to regenerate it or to incinerate it.

The steam treatment purifies the hydrogenation catalysts to such an extent that the eluate obtained in the steam purification has an evaporation residue ER of ≦2%.

The process of the present invention is used for working up at least partially deactivated hydrogenation catalysts for the color number hydrogenation of PTHF and/or PTHF esters, preferably PTHF monoacetates and/or PTHF diacetates. The hydrogenation catalyst for the color number hydrogenation is considered to be partially deactivated when it has lost its original catalytic activity and/or when the color number of the polymer can no longer be reduced significantly by the color number hydrogenation. A partially deactivated hydrogenation catalyst can, for example, have a residual activity of 80% of the original activity. It is possible to work up hydrogenation catalysts which have been used for the color number hydrogenation of polymers from the polymerization of THF to PTHF or from the copolymerization of THF with alkylene oxides such as ethylene oxide or propylene oxide to form the corresponding polybutylene-alkylene glycol ethers. The polymerization can also have been carried out as a copolymerization in the presence of telogens. Examples of telogens are water, monohydric or polyhydric alcohols such as methanol, ethanol, propanol, ethylene glycol, butylene glycol, glycerol, neopentyl glycol, 1,4-butanediol, also aliphatic carboxylic acids having from 1 to 8 carbon atoms, e.g. formic acid, acetic acid, propionic acid, butyric acid, and aromatic carboxylic acids such as benzoic acid and also their anhydrides.

The at least partially deactivated hydrogenation catalysts from the color number hydrogenation are contaminated with the products of the polymerization or copolymerization. Products of the polymerization or copolymerization are PTHF, polybutylene-alkylene glycol ethers or their reaction products with the telogens mentioned, e.g. PTHF monoesters, PTHF diesters.

The process of the present invention is used for the work-up of hydrogenation catalysts for color number hydrogenation. Suitable hydrogenation catalysts are known, for example, from DE-A 31 12 065 and comprise metals of transition group 8, in particular nickel, cobalt, iron and also the noble metals ruthenium, palladium or platinum, also copper. The metals can be employed in pure form, e.g. as Raney metals or as reduced oxides. However, catalysts comprising the hydrogenation metals on suitable supports such as aluminum oxide, silicon oxide, pumice, bentonite or, for example, magnesium silicate have also been found to be useful. The catalysts comprising base metals such as iron, cobalt, nickel and copper are advantageously converted into the active form by reduction with hydrogen prior to use. When noble metal catalysts are employed, such an operation is superfluous in most cases. The process of the present invention is preferably applied to hydrogenation catalysts for color number hydrogenation which comprise nickel and copper and are preferably supported.

To carry out the process of the present invention, the color number hydrogenation reactor is emptied by draining off the reaction mixture. The catalyst remaining in the reactor is then treated continuously or discontinuously with steam, preferably from the top downward, at from 100 to 250° C., preferably from 100 to 200° C., particularly preferably from 100 to 150° C., and a gauge pressure of from 0 to 40 bar, preferably from I to 16 bar, particularly preferably from 2 to 4 bar.

The physical stripping effect of the steam restores the free-flowing nature of the hydrogenation catalyst, so that it can be removed from the hydrogenation reactor without problems. Any catalyst beds in any reaction apparatuses can be worked up in this way. For example, the catalyst can be present in the form of crushed material, extrudates, spheres or other shaped bodies. The purified catalyst can, for example, be removed from the hydrogenation reactor by means of suction or by draining it out from the bottom.

The time for which the catalyst is treated with steam is generally from 2 to 100 hours, particularly preferably from 5 to 50 hours.

Condensation of the steam, either in the hydrogenation reactor or preferably in a separate apparatus, gives an eluate (condensate) comprising water and impurities removed from the catalyst.

PTHF, PTHF monoesters or PTHF diesters present in this eluate can be separated off by, for example, phase separation. It is also possible to work up the eluate by distillation. Furthermore, the PTHF and/or PTHF esters present can be depolymerized in a separate apparatus. The monomers obtained by depolymerization can be recirculated. The residual condensate which remains can be sent as wastewater to a water treatment plant.

The hydrogenation catalyst for color number hydrogenation which has been purified by the process of the present invention is free of PTHF and/or PTHF esters and can, since it is fine-grained and free-flowing, be removed from the reactor by means of suction without problems. The process of the present invention makes friction-free removal of the catalyst from the reactor possible. The deactivated hydrogenation catalyst from color number hydrogenation of PTHF and/or PTHF esters is preferably passed to metal recovery. It is also possible for it to be deposited in a landfill, regenerated or incinerated.

The following examples illustrate the invention.

Color Number Hydrogenation

Tetrahydrofuran was polymerized by the continuous polymerization method described in DE-A 29 16 653 (U.S. Pat. No. 4,189,566) using bleaching earth as catalyst and acetic anhydride as regulator substance. The pretreatment likewise described in this publication for purifying commercial tetrahydrofuran was omitted. The polymerization was carried out using technical-grade tetrahydrofuran from BASF Aktiengesellschaft. A PTHF diacetate having a molecular weight of 650 was prepared as described in example 3 of DE-A 29 16 653. This polymer had a color number of 100 APHA. The PTHF diacetate leaving the reactor was passed from the bottom upward over a catalyst bed comprising 3 mm silica gel extrudates containing 0.4% of palladium while introducing gaseous hydrogen. The product leaving the hydrogenation had a color number of less than 10 APHA. The space velocity of the catalyst was 0.4 kg of polymer solution per liter of catalyst and hour. The amount of hydrogen introduced per hour was 1 standard l/l of polymer solution. The polymer solution which had been treated by hydrogenation was freed of excess tetrahydrofuran and the resulting diacetate was hydrolyzed. This finally gave PTHF having a color number of about 15 APHA and an acid number of 0 mg KOH/g.

### EXAMPLE 1

The partially deactivated catalyst used for the above-described color number hydrogenation was, after a period of operation of 23 months, treated with 4 bar steam from the top downwards at 160° C. for 24 hours. The flow rate was about 1 t/h.

After 24 hours, a very free-flowing catalyst bed was obtained and this could be removed by means of suction without problems. The condensate obtained toward the end had TOC contents of <1%. The further analytical values are shown in table 1. The corresponding values for a condensate obtained right at the beginning of the steam treatment are also shown in table 1 as example C1.

Determination of the Acid Number (AN)

The acid number is determined by means of equivalence point titration with potassium hydroxide (KOH). The acid number gives the amount of potassium hydroxide in mg which is required to neutralize 1 g of the sample.

Determination of the Evaporation Residue (ER)

The evaporation residue is the proportion of nonvolatile material present in PTHF or PTHF ester/low boiler mixtures determined under prescribed conditions. To determine the ER, a sample is evaporated for 60 minutes at 140° C. under atmospheric pressure and for 30 minutes at the same temperature and a pressure of less than 1 mbar in an evaporation flask. The evaporation residue is calculated according to

$$ER = \frac{{m}_{2} \times 100}{{m}_{1}}$$

In this equation,
ER=Evaporation residue, mass fraction in accordance with DIN 1310 in g/100 g
m₁=Mass in g of the evaporation flask with the sample
m₂=Mass in g of the evaporation flask with the evaporation residue
100=Conversion factor from g to 100 g
   Determination of the THF Content

The THF content of the eluate was determined gas-chromatographically (head space gas chromatography).

TABLE 1

| | ER | AN | THF |
|---|---|---|---|
| Example | [%] | [mg KOH/g] | [ppm] |
| C1 | 17.4 | 5.7 | 29171 |
| 1 | 1.28 | 10.6 | 652 |

1. A process for working up an at least partially deactivated hydrogenation catalyst for the color number hydrogenation of PTHF and/or PTHF esters, comprising purifying a hydrogenation catalyst comprising nickel, cobalt, iron, ruthenium, palladium, platinum or copper by treatment with steam at from 100 to 250° C. and a gauge pressure of from 0 to 40 bar.

2. A process as claimed in claim 1, wherein the hydrogenation catalyst is a supported catalyst.

3. (canceled)

4. A process as claimed in claim 1 for working up hydrogenation catalysts for the color number hydrogenation of PTHF monoacetate and/or PTHF diacetate.

5. A process as claimed in claim 2 for working up hydrogenation catalysts for the color number hydrogenation of PTHF monoacetate and/or PTHF diacetate.
